(19) United States
(12) Patent Application Publication
(10) Pub. No.: US 2018/0330489 A1
(43) Pub. Date: Nov. 15, 2018

(54) Image Inspection Device

(71) Applicant: Keyence Corporation, Osaka (JP)

(72) Inventor: Manabu Kido, Osaka (JP)

(73) Assignee: Keyence Corporation, Osaka (JP)

(21) Appl. No.: 15/925,804

(22) Filed: Mar. 20, 2018

(30) Foreign Application Priority Data
May 9, 2017 (JP) 2017-093358

(51) Int. Cl. G06T 7/00; G06T 3/00

(52) U.S. Cl. CPC G06T 7/0004; G06T 2207/10152; G06T 2207/30164; G06T 3/0081

(57) ABSTRACT

The invention improves accuracy of image inspection for a moving workpiece in an image inspection device provided with a plurality of light sources having different lighting colors. A first movement correction image is acquired before acquiring spectral images for multi-spectral imaging. A second movement correction image is acquired after acquiring the spectral images for multi-spectral imaging. Positions of the workpiece in the spectral images are corrected based on the amount of change between a position of a characteristic of a workpiece in the first movement correction image and a position of the characteristic of the workpiece in a second movement correction image thereby creating an inspection image. Image inspection on the workpiece is executed using this inspection image.

### CROSS-REFERENCE TO RELATED APPLICATIONS

The present application claims foreign priority based on Japanese Patent Application No. 2017-093358, filed May 9, 2017, the contents of which is incorporated herein by reference.

### BACKGROUND OF THE INVENTION

### 1. Field of the Invention

The present invention relates to an image inspection device using multi-spectral imaging.

### 2. Description of Related Art

Image inspection devices that inspect an image obtained by capturing an image of a workpiece to determine whether a product (workpiece) has been produced as designed are extremely useful. A shape, a size, a color, and the like of the workpiece are inspected in such image inspection. JP H09-126890 A proposes a color detecting apparatus which captures an image of an inspection target object such as a printed matter to acquire color information and executes color inspection with high accuracy.

Meanwhile, desired color information is realized by selecting a wavelength by a color filter on a camera side or selecting a wavelength of an illumination beam. In the former selection, for example, a workpiece is irradiated with white light by a white light source and reflected light of a desired wavelength out of the light reflected from the workpiece is selected by a spectral optical system. This may be realized by using an imaging element including a plurality of color filters having different pass wavelengths. When an RGB color filter is used, an R image, a G image, and a B image can be obtained. In the latter selection, for example, an R image is acquired by irradiating a workpiece with a red illumination beam by a red LED, a G image is acquired by irradiating the workpiece with a green illumination beam by a green LED, and a B image is acquired by irradiating the workpiece with a blue illumination beam by a blue LED. The latter imaging method is called multi-spectral imaging, and basically, each color LED is alternatively turned on. Further, a large number of spectral images can be obtained when a large number of light sources having different wavelengths are employed so that even a subtle color difference can be discriminated.

The image inspection device provided with the plurality of light sources having different wavelengths in this manner acquires a large number of spectral images while changing wavelengths of illumination beams. Thus, a long time is required until acquiring a last image since acquisition of a first image.

In general, the workpiece is inspected while being conveyed by a belt conveyor, and thus, a position of the workpiece in the first image and a position of the workpiece in the last image deviate from each other. If an inspection image is generated using a large number of spectral images without correcting the position of the workpiece, it is difficult to obtain a correct inspection image and accuracy of image inspection may decrease. Therefore, an object of the present invention is to improve the accuracy of image inspection for a moving workpiece in an image inspection device provided with a plurality of light sources having different wavelengths (lighting colors).

### SUMMARY OF THE INVENTION

For example, the present invention provides an image inspection device including: an illumination unit which includes a plurality of light emitting elements that generate illumination beams of a plurality of mutually different lighting colors and irradiates a target object with the illumination beams of respective lighting colors; an imaging unit which receives light reflected from the target object for each of illumination beams of one or more lighting colors and generates an image of the target object; a control unit which controls the illumination unit to irradiate the target object with a plurality of illumination beams having mutually different lighting colors, controls the imaging unit to generate a plurality of images having the same or mutually different lighting colors of illumination beams at constant time intervals; a search unit which searches a position of a characteristic pattern for each of a first movement correction image acquired under the illumination beam of the same lighting color and a second movement correction image generated after the first movement correction image; a correction unit which corrects correspondence relationship among coordinates of pixels in the plurality of images based on a change amount between a position of a characteristic pattern in the first movement correction image and a position of the characteristic pattern in the second movement correction image; and an inspection unit which executes image inspection of the target object based on the plurality of images with the correspondence relationship among the coordinates of the respective pixels corrected by the correction unit.

According to the present invention, the accuracy of the image inspection for the moving workpiece is improved in the image inspection device provided with the plurality of light sources having different lighting colors.

### BRIEF DESCRIPTION OF THE DRAWINGS

FIG. 1 is a view illustrating an image inspection device;

FIGS. 2A to 2D are views illustrating an illumination device;

FIGS. 3A to 3E are views illustrating parts constituting the illumination device;

FIG. 4 is a diagram illustrating an electrical configuration of the illumination device;

FIG. 5 is a diagram illustrating functions of an image processing system;

FIG. 6 is a view illustrating a principle of color gray-scale conversion in multi-spectral imaging;

FIG. 7 is a view for describing a problem of movement of a workpiece;

FIG. 8 is a view for describing a principle of movement correction in multi-spectral imaging;

FIG. 9A is a view illustrating a user interface relating to movement correction;

FIG. 9B is a view illustrating a user interface relating to movement correction;

FIG. 10 is a view illustrating a user interface relating to movement correction;

FIG. 11 is a flowchart illustrating image inspection;

FIG. 12 is a view illustrating a lighting pattern;

FIG. 13 is a diagram illustrating functions of the image processing system;

FIG. 14 is a diagram illustrating functions of the image processing system;

FIG. 15 is a diagram illustrating functions of the image processing system; and

FIG. 16 is a view illustrating an illumination device.

### DETAILED DESCRIPTION OF PREFERRED EMBODIMENT

One embodiment of the present invention will be described below. Individual embodiments to be described below will be useful for understanding various concepts of the present invention such as superordinate concepts, intermediate concepts, and subordinate concepts. In addition, it should be understood that the technical scope of the present invention is defined by the scope of the claims and is not limited by the individual embodiments below.

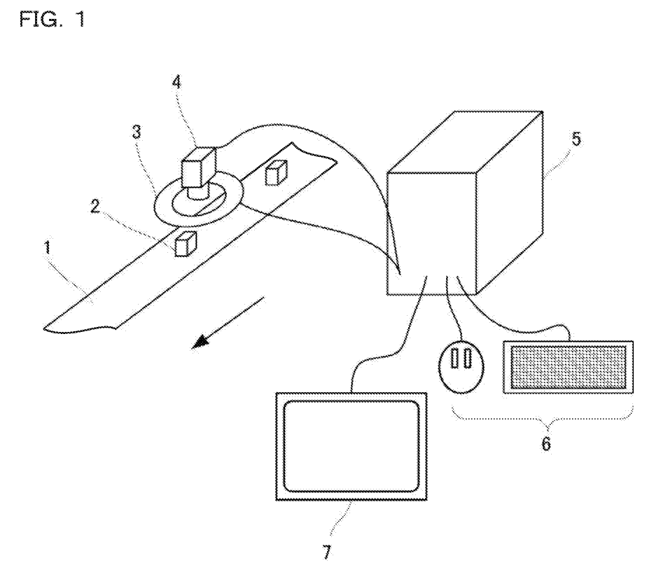

FIG. 1 is a view illustrating an example of a visual inspection system (image inspection device). A line 1 is a conveyor belt or the like for conveying a workpiece 2 which is an inspection target object. The workpiece 2 moves an inspection region in one direction. An illumination device 3 is an example of an illumination unit which includes a plurality of light emitting elements that generate inspection light (illumination beams) of mutually different wavelengths, and individually irradiates the target object with the illumination beam of each wavelength. A plurality of light emitting elements having the same wavelength may be provided in order to irradiate the workpiece 2 with the illumination beam from a plurality of directions. A camera 4 is an example of an imaging section for receiving light reflected from the inspection target object illuminated by the illumination beam and generating a luminance image (spectral image). An image processing device 5 is an inspection device which includes an inspection unit which illuminates the inspection target object to be subjected to image inspection by sequentially turning on the light emitting elements at illumination intensity set for each wavelength, and executes the image inspection using a plurality of inspection images acquired by the imaging unit. A display unit 7 is a display device which displays a user interface for setting a control parameter relating to the inspection, the inspection images, and the like. An input unit 6 is a console, a pointing device, a keyboard, or the like, and is used to set the control parameter.

<Configuration of Illumination Device>

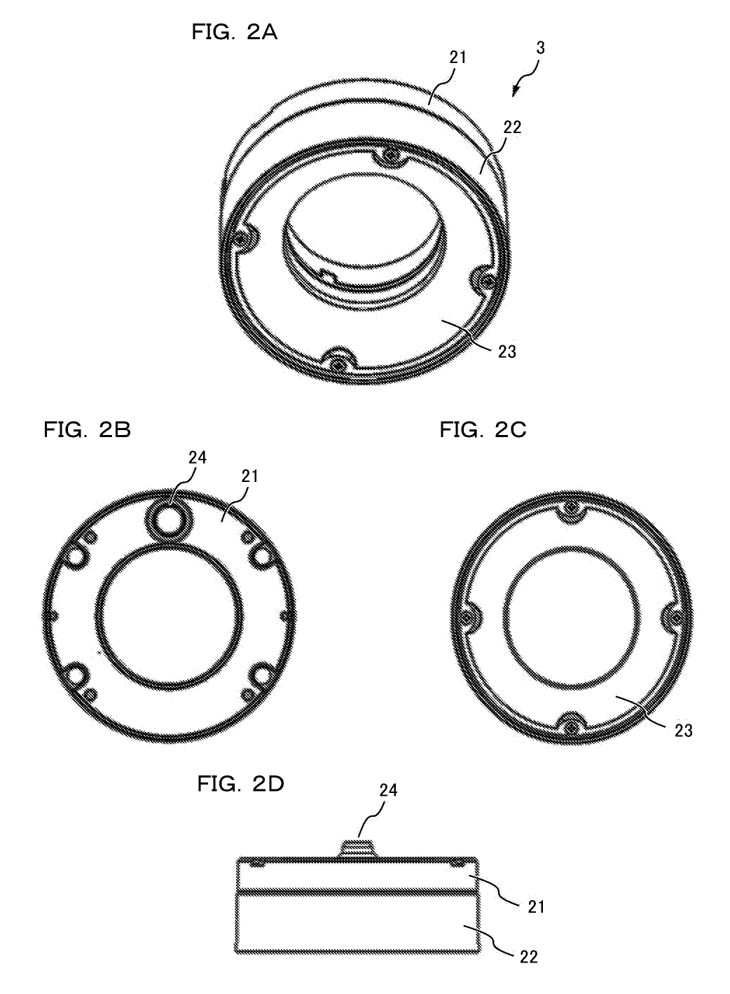

FIG. 2A is a perspective view of the illumination device 3. FIG. 2B is a top view of the illumination device 3. FIG. 2C is a bottom view of the illumination device 3. FIG. 2D is a side view of the illumination device 3. A casing of the illumination device 3 includes an upper case 21 and a lower case 22. A light diffusing member 23 which diffuses light output from each of a plurality of light sources (light emitting elements such as LEDs) is arranged at a lower part of the lower case 22. As illustrated in FIGS. 2A and 2C, the light diffusing member 23 also has an annular shape similarly to the upper case 21 and the lower case 22. As illustrated in FIGS. 2B and 2D, a connector 24 is provided on an upper surface of the upper case 21. A cable for communication between an illumination control board housed in the illumination device 3 and the image processing device 5 is connected to the connector 24. Some functions mounted on the illumination control board may be provided outside the illumination device 3 as an illumination controller. That is, the illumination controller may be interposed between the illumination device 3 and the image processing device 5.

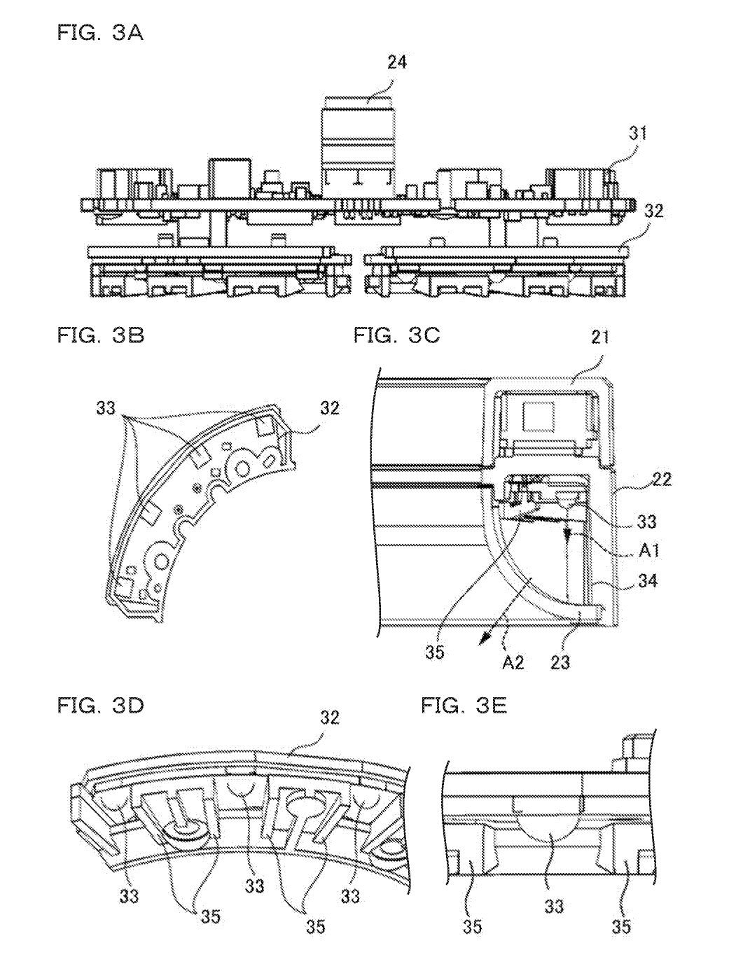

FIG. 3A is a side view illustrating a control board 31 and an LED board 32 housed in the illumination device 3. The control board 31 is an example of a second board on which a lighting control unit is mounted. The LED board 32 is an example of a first board on which the plurality of light sources are mounted. FIG. 3B is a top view of the LED board 32. FIG. 3C is an enlarged cross-sectional view of the vicinity of an LED 33 in the illumination device 3. FIG. 3D is a bottom view of the LED board 32. FIG. 3E is an enlarged side view of the vicinity of the LED 33 in the LED board 32.

The illumination control board and the connector 24 are arranged on the control board 31. The light emitting elements such as LEDs constituting a light source group are mounted on the LED board 32. As illustrated in FIG. 3B, four LED boards 32 are provided for irradiation of the illumination beam from four directions in the present embodiment. As the irradiation of the illumination beam from the four directions is possible, it is possible to acquire a photometric stereo image. That is, the illumination device 3 may be used not only for multi-spectral imaging but also for photometric stereo. It is assumed that four LEDs 33 are arranged on the one LED board 32. As a result, the light source group is constituted by sixteen light emitting elements. Meanwhile, a larger number of light emitting elements may be provided. For example, eight LEDs 33 may be arranged on the one LED board 32, and wavelengths of light emitted by the eight LEDs 33 may be different from each other. As illustrated in FIGS. 3C, 3D, and 3E, a light shielding member 35 is arranged between the two adjacent LEDs 33 among the plurality of LEDs 33. When a large number of the LEDs 33 are closely arranged, illumination beams irradiated, respectively, from the two adjacent LEDs 33 may pass through the same region of the light diffusing member 23 in some cases. In this case, the surface of the workpiece 2 is irradiated with the illumination beams with the same amount of light from the same illumination direction in both of a case where one of the LEDs 33 is turned off and the other LED 33 is turned on and a case where the other LED 33 is turned off and the one LED 33 is turned on according to a lighting pattern. Then, it is difficult to generate the inspection images with high accuracy. Thus, a balance between uniformity of the amount of light and independence of the light source is obtained for the two adjacent LEDs 33 by arranging the light shielding member 35 between the two adjacent LEDs 33. As illustrated in FIG. 3C, a light emission direction A1 of the LED 33 does not coincide with a main illumination direction A2. Thus, the light emitted from the LED 33 is deflected toward the light diffusing member 23 by arranging a reflector 34. As a result, it is possible to efficiently irradiate the workpiece 2 with the light emitted from the LED 33. The emission direction A1 and a reflection direction of the reflector 34 are substantially orthogonal to each other in this example since a cross-sectional shape of the light diffusing member 23 forms an arc (FIG. 3C)) and an angle (central angle) of the arc is about 90 degrees. As the central angle is set large in this manner, it is easy to irradiate the surface of the workpiece 2 with substantially uniform parallel light even if the illumination device 3 is moved away from or close to the workpiece 2.

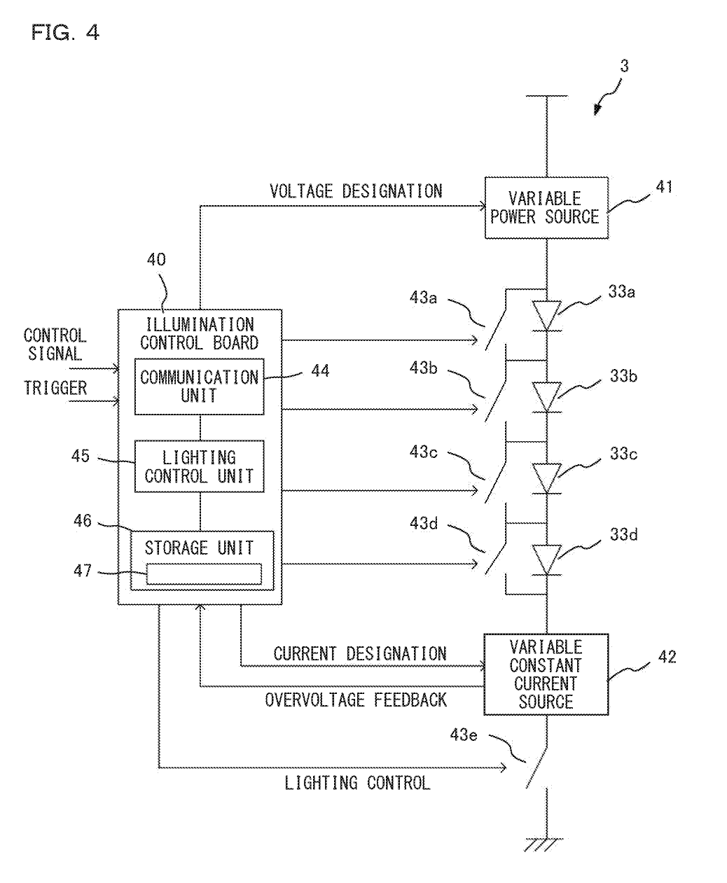

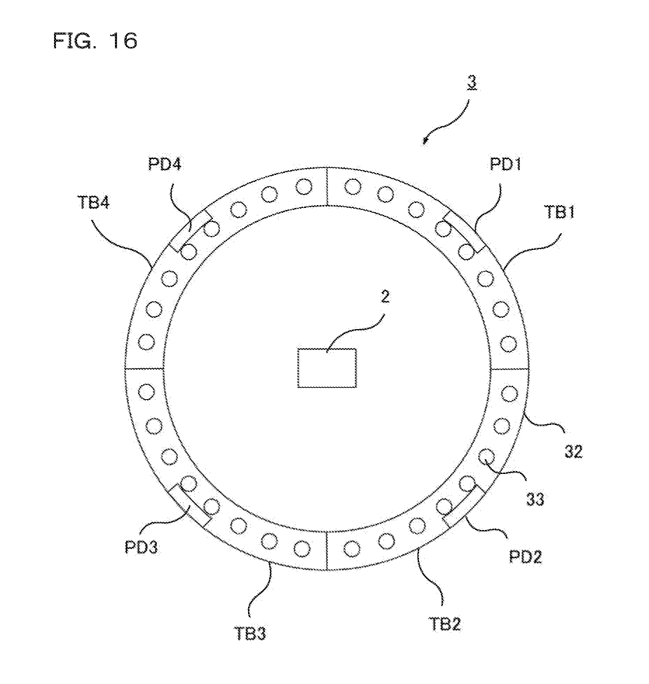

FIG. 16 is a schematic plan view of the illumination device 3. The plurality of LEDs 33 that emit light of mutually different wavelengths are arranged in an annular shape on the LED board 32 of the illumination device 3. The illumination control board (FIG. 4) provided on the control board 31 simultaneously turns on the plurality of LEDs 33 having the same wavelength. The plurality of LEDs 33 having the same wavelength are arranged on the LED board 32 at equal intervals. As the plurality of LEDs 33 having each wavelength are simultaneously turned on, the workpiece 2 is irradiated with the substantially uniform illumination beam from an obliquely upper side of the workpiece 2. Accordingly, the camera 4 can capture an omni-directional illumination image of the workpiece 2 corresponding to the respective wavelengths that does not depend on an irradiation direction.

The illumination device 3 is constituted by four illumination blocks TB1 to TB4 each of which includes the plurality of LEDs 33. The plurality of LEDs 33 that emit light of mutually different wavelengths are arranged in each illumination block. Each illumination block includes the LEDs 33 of all wavelength types provided in the illumination device 3. Light receiving elements PD1 to PD4 for light amount feedback control are arranged in each illumination block. The illumination control board controls a current value to be supplied to each of the LEDs 33 such that a light amount of each illumination block is maintained at a light amount set in advance based on a receiving amount of light received by the light receiving elements PD1 to PD4.

The LEDs 33 of the respective wavelengths are arranged in the same number and at equal intervals in the respective illumination blocks. In the example illustrated in FIG. 16, the LEDs 33 of eight wavelengths are arranged one by one at equal intervals in each illumination block. Each illumination block may include two or more LEDs 33 of the same wavelength. In this case, each illumination block is provided with a multiple of the number of wavelengths, for example, 16 (8 wavelengths×2), 24 (8 wavelengths×3), or 32 (8 wavelengths×4) LEDs 33. The plurality of LEDs 33 having the same wavelength are arranged at equal intervals in each illumination block. The above-described arrangement of the LEDs 33 is common to all the illumination blocks. A ring-type illumination is configured by arranging the plurality of illumination blocks in an annular shape. That is, the LEDs 33 having the same wavelength are arranged at equal intervals in the annular shape.

The illumination control board can perform individual lighting control of the illumination device 3 in units of wavelengths. When the LED 33 of a single wavelength, for example, red is turned on, the illumination control board simultaneously turns on the red LEDs 33 included in all the illumination blocks. By sequentially turning on the LEDs 33 of each wavelength, the illumination control board can irradiate the workpiece 2 sequentially with light of different wavelengths. In addition, the illumination control board can perform individual lighting control of each illumination block. For example, the illumination control board may turn on the LEDs 33 included in the illumination block TB1 and turn off the LEDs 33 included in the illumination blocks TB2 to TB4. In addition, the illumination control board can also turn on the illumination blocks TB1 to TB4 sequentially (in the order of TB1, TB2, TB3, TB4). By switching the illumination block to be turned on by the illumination control board, a plurality of luminance images of the workpiece 2 illuminated from different directions may be acquired and used for inspection. Further, the illumination control board can also perform individual lighting control of the LED 33 in units of both wavelengths and illumination blocks. For example, the illumination control board can turn on only the red LED 33 included in the illumination block TB1.

By performing the lighting control of the LEDs 33 in units of wavelengths in this manner, the illumination device 3 irradiates the workpiece 2 with light of different wavelengths. In addition, by performing the lighting control of the LEDs 33 in units of the respective illumination block, it is possible to irradiate the workpiece 2 with light from different irradiation directions.

Not only the monochromatic LED 33 but also the white LED 33 that emits white light in which beams of a plurality of wavelengths are mixed may be arranged on the control board 31. The illumination control board may selectively turn on only the white LED 33 so that the illumination device 3 in the present embodiment is made to function in the same manner as a typical white ring illumination. Further, the illumination control board can also irradiate the workpiece 2 with substantially the white light by simultaneously turning on the LEDs 33 of all wavelengths.

In the present specification, the image obtained by the illumination control board irradiating the workpiece 2 with the illumination beam of the monochromatic wavelength is called a spectral image. In addition, the image obtained by turning on the LEDs 33 of all wavelengths or turning on the white LED 33 is distinguished from the spectral image and is called a white image. The spectral image and the white image may be collectively referred to as the luminance image. Each pixel of the luminance image indicates a luminance value obtained from the camera 4.

Each illumination block is provided with the illumination control board. When each illumination block includes the plurality of LEDs 33 having the same wavelength, the LEDs 33 having the same wavelength are connected in series to each illumination control board, and the LEDs 33 having different wavelengths are connected in parallel.

<Circuit Configuration of Illumination Device>

FIG. 4 illustrates an example of a circuit configuration of the illumination device 3. In this example, one illumination block out of the four illumination blocks constituting the light source group is illustrated, and each illumination block is provided with four LEDs (LED 33a to LED 33d) having the same wavelength. The four LEDs 33a to 33d are connected in series. LEDs having different wavelengths connected in series in the same manner are connected in parallel with the circuit configuration of FIG. 4, but are not illustrated in FIG. 4. A variable power source 41 with a variable voltage generates and outputs a voltage having a voltage value (for example, 2 V to 20 V) designated by an illumination control board 40. A variable constant current source 42 adjusts a current flowing in an LED group so as to have a current value (for example, 0 A to 1 A) designated by the illumination control board 40. As such a current control system is employed, it is easy to realize dimming with high linearity. In addition, the variable constant current source 42 detects a value of a voltage applied to the variable constant current source 42 and performs feedback to the illumination control board 40, thereby protecting the variable constant current source 42 from an overvoltage. Switches 43a to 43d are connected in parallel to the LEDs 33a to 33d, respectively. A lighting control unit 45 of the illumination control board 40 can individually switch on and off of each of the LEDs 33a to 33d by individually opening and closing these switches 43a to 43d. As the switches 43a to 43d are connected in parallel to the LEDs 33a to 33d, respectively, in this manner, it is possible to perform the individual lighting by turning on any one of the LEDs 33a to 33d or turning on all of the LEDs 33a to 33d. This is useful for realizing various lighting patterns. The lighting control unit 45 executes the lighting control in the unit of one LED group by switching on/off of a main switch 43e inserted between the variable constant current source 42 and a ground. A communication unit 44 receives a control signal to instruct a lighting pattern and a trigger signal to instruct start of lighting from an illumination control unit of the image processing device 5, and sends the signals to the lighting control unit 45. The lighting control unit 45 reads lighting pattern data 47 corresponding to the control signal from a storage unit 46 and controls the switches 43a to 43d according to the lighting pattern data 47.

<Functional Block>

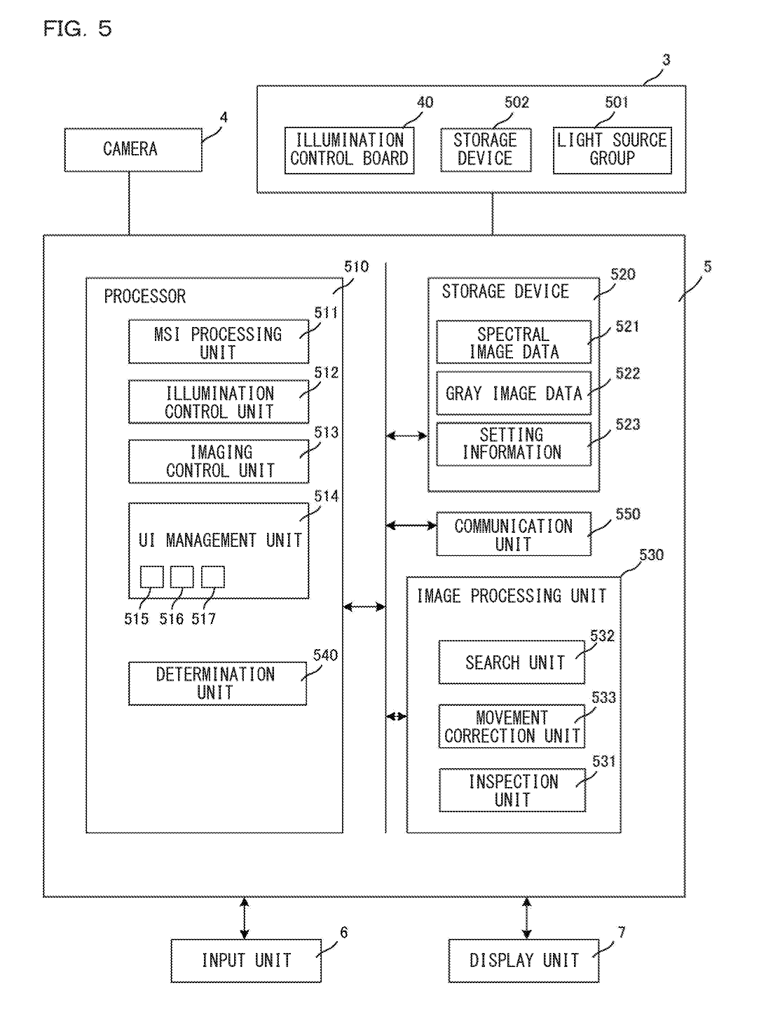

FIG. 5 is a block diagram of an inspection device. In this example, the illumination device 3, the camera 4, and the image processing device 5 are housed in individual casings, respectively, but this is merely an example, and the integration thereof may be obtained as appropriate. The illumination device 3 is the illumination device that realizes the multi-spectral imaging, but may be used as an illumination section that illuminates an inspection target object according to a photometric stereo method. The illumination device 3 includes a light source group 501 and the illumination control board 40 that controls the light source group 501. As already illustrated in FIGS. 3A to 3E, one segment may be constituted by the plurality of light emitting elements, and the light source group 501 may be constituted by the plurality of segments. The number of segments is generally four, but may be three or more. This is because it is possible to generate an inspection image by the photometric stereo method if the workpiece 2 can be irradiated with illumination beams from three or more illumination directions. Each segment is provided with the plurality of light emitting elements (LEDs 33) that output illumination beams having different wavelengths, respectively. The plurality of light emitting elements may include the white LED. The white LED is not used for the multi-spectral imaging but can be used to create another inspection image and to create an image for movement correction of the workpiece 2. As illustrated in FIGS. 1 and 3A to 3E, an outer shape of the illumination device 3 may have a ring shape. In addition, the illumination device 3 may be constituted by a plurality of illumination units separated from each other. The illumination control board 40 controls a lighting timing and an illumination pattern (lighting pattern) of the light source group 501 according to a control command received from the image processing device 5. The workpiece 2 is irradiated with illumination beams of alternately selected wavelengths when acquiring the spectral image by the multi-spectral imaging, but may be irradiated simultaneously with the illumination beams of a plurality of wavelengths when a method other than the multi-spectral imaging is adopted. The illumination control board 40 has been described as being built in the illumination device 3, but may be built in the camera 4 or the image processing device 5, or may be housed in a casing independent therefrom.

A storage device 502 is built in the illumination device 3, and the lighting timing and the illumination pattern of the light source group 501 set by the user are stored therein. The illumination control board 40 can receive the trigger signal from the image processing device 5 and control the light source group 501 according to contents stored in the storage device 502. With this configuration, the image processing device 5 can control the illumination device 3 only by transmitting the trigger signal, and thus, it is possible to reduce the number of signal lines that connect the image processing device 5 and the illumination device 3, thereby improving the handling of cables.

More specifically, the storage device 502 stores illumination setting data that includes lighting timing information (a lighting time and a lighting interval), illumination intensity information, illumination pattern information (identification information of a wavelength to be turned on), and illumination block information (identification information of a block to be turned on) of the light source group 501 of each wavelength. All of the illumination setting data causes the user interface for illumination setting to be displayed on the display unit 7, and an illumination setting section receives adjustment made by the user.

The lighting timing information is information that defines a lighting timing of each wavelength when the light source group corresponding to each wavelength is periodically turned on, and includes the lighting time (pulse width) in which the light source group of each wavelength is turned on, and the lighting interval (interval) from turning-on of the light source group of a previous wavelength to turning-on of the light source group of a next wavelength at the time of switching the wavelength to be turned on. For example, when the user performs inspection using a light source group emitting red and green light, the user can set a lighting time of the light source group of a red wavelength, a lighting time of the light source group of a green wavelength, and an interval between both the lighting times. The user may individually set the lighting time of each wavelength, or the setting of the lighting time may be common to the entire wavelength. Regarding the setting of the lighting interval, the user may directly designate the lighting interval, or the lighting interval may be automatically calculated based on a length of one lighting cycle for sequentially turning on the light source group of the entire wavelength used for inspection and the lighting time of each wavelength.

The illumination intensity information is information that indicates the illumination intensity of each wavelength. The illumination intensity of each wavelength can be individually set in the present embodiment, and thus, it is possible to irradiate the workpiece with light with an optimum illumination intensity at each wavelength.

The illumination pattern information is identification information that indicates a type of the wavelength to be turned on, and is information used to decide which light source group corresponding to which wavelength needs to be turned on at each lighting timing. For example, when the user performs setting of inspection using three colors of red, green, and purple, the storage device 502 stores the identification information indicating these three wavelengths in association with the information on each lighting timing (lighting pulse). For example, the storage device 502 stores the illumination pattern information in association with the lighting timing information such that a red light source group is turned on with a first lighting pulse, a green light source group is turned on with a next lighting pulse, and a purple light source group is turned on with a last lighting pulse. Information indicating an order of lighting wavelengths may be included in the illumination pattern information. In the above example, the order of red, green, and purple may be set by the user, or a lighting order of wavelengths that can be set may be fixed and determined in advance. A storage device 520 of the image processing device 5 shares the illumination pattern information with the illumination device 3. In the above example, an image acquired first is processed as an image obtained with a red wavelength, an image acquired next is processed as an image obtained with a green wavelength, and an image acquired last is processed as an image obtained with a purple wavelength.

The illumination block information is identification information on the illumination block to be turned on. In the present embodiment, it is possible to individually control lighting in units of illumination blocks as well as to individually control lighting in units of wavelengths. The user can execute inspection using oblique illumination by arbitrarily selecting the illumination block to be turned on. In addition, it is also possible to generate a shape image using the principle of photometric stereo based on a plurality of luminance images obtained by illuminating light from different illumination directions by sequentially turning on all the illumination blocks. The user can also set an order of illumination blocks to be turned on. Illumination block to be turned on may be arbitrarily designated at each lighting timing, or a rotation direction of lighting (clockwise or counterclockwise) may fixed such that the user can designate an illumination block to be turned on first.

The illumination setting data set by the illumination setting section may be set from an input unit such as a personal computer (PC) connected to the illumination device 3 or from the image processing device 5 connected to the illumination device 3. In addition, the illumination device 3 may receive the setting via a controller for illumination which is provided separately from the image processing device 5. In addition, it is also possible to directly perform the illumination setting in an inspection device via the input unit 6 in the case of the inspection device in which the camera 4, the illumination device 3, and the image processing device 5 are integrally provided.

The storage device 502 is provided in the illumination device 3 in the above example, but may be provided in the image processing device 5. In addition, the storage device 502 may be provided in the camera 4 when the illumination device 3 and the camera 4 are integrally provided. When the illumination device 3, the camera 4, and the image processing device 5 are integrally provided in one housing, the storage device 502 is provided in the housing.

The camera 4 is an example of the imaging section that receives light reflected from the inspection target object illuminated by the illumination device 3 and generates the luminance image, and executes imaging processing according to the control command from the image processing device 5. The camera 4 may create a luminance image of the workpiece 2 and transfer the created luminance image to the image processing device 5, or a luminance signal obtained from an imaging element may be transferred to the image processing device 5 so that the image processing device 5 generates a luminance image. Since the luminance image is based on the luminance signal, the luminance signal is also the luminance image in a broad sense. In addition, the camera 4 functions as the imaging unit that receives the light reflected from the target object for each of illumination beams of the respective wavelengths output from the illumination device 3 and generates the image of the target object.

The image processing device 5 is a type of computer, and includes a processor 510 such as a CPU and an ASIC, the storage device 520 such as a RAM, a ROM, and a portable storage medium, an image processing unit 530 such as an ASIC, and a communication unit 550 such as a network interface. The processor 510 performs setting of an inspection tool, adjustment of the control parameter, generation of the inspection image, and the like. In particular, an MSI processing unit 511 creates a gray image of the workpiece 2 from a plurality of luminance images (spectral images) acquired by the camera 4 or creates an inspection image from the gray image according to multi-spectral imaging (MSI). That is, an illumination control unit 512 transmits a trigger signal to start illumination to the illumination device 3. An imaging control unit 513 transmits a trigger signal to start imaging in synchronization with the trigger signal issued from the illumination control unit 512 to the camera 4, thereby controlling the camera 4.

A UI management unit 514 displays a user interface (UI) for setting of the inspection tool, a UI for setting of a parameter required to generate the inspection image, and the like on the display unit 7, and sets the inspection tool and the parameter according to the information input from the input unit 6. The inspection tool may include a tool to measure a length of a specific characteristic (for example, a pin) provided in the workpiece 2, a tool to measure the area of the characteristic, a tool to measure a distance from a certain characteristic to another characteristic (for example, a pin interval) from one characteristic to another, a tool to measure the number of specific characteristics, a tool to inspect whether there is a flaw on a specific characteristic, and the like. In particular, the UI management unit 514 displays a UI for setting of a control parameter relating to multi-spectral imaging and movement correction on the display unit 7. An image selection unit 515 reads image data of an image selected by the user through the UI from the storage device 520 and displays the image in an image display region inside the UI. A region designation unit 516 receives designation of the inspection region (measurement region) of the inspection tool, a pattern region PW, a search region SW, a tracking region TW, and the like with respect to the displayed image from the user. The pattern region PW and the tracking region TW are regions configured to register characteristic patterns for movement correction. The search region SW is a region where the characteristic pattern is searched. In addition, the region designation unit 516 receives selection of shapes (for example, a rectangle, a circle, an ellipse, or an arbitrary shape) of these designation regions and reflects a shape of a frame line indicating the designation region to the UI. A lighting color setting unit 517 sets a wavelength of an illumination beam for movement correction according to the user's instruction. The UI management unit 514 saves these control parameters set by the user in setting information 523.

The image processing unit 530 includes an inspection unit 531, which executes various types of measurement by applying the inspection tool to the inspection image acquired by the multi-spectral imaging, and the like. A search unit 532 searches for a characteristic set before image inspection or a characteristic dynamically set during the image inspection within a search region SW arranged in the inspection image, and obtains a position of the found characteristic. A movement correction unit 533 corrects a coordinate system of a plurality of spectral images for multi-spectral imaging or coordinates (position) of the workpiece 2 based on the change amount of the position of the characteristic found from the image for movement correction. This correction work may be divided into a step of creating a conversion formula (correction formula) for correction and a step of converting coordinates using the conversion formula. Both of these two processes may be executed by the movement correction unit 533, the former process may be executed by the movement correction unit 533 and the latter process may be executed by the MSI processing unit 511, or both of the processes may be executed by the MSI processing unit 511. The function of the image processing unit 530 may be implemented on the processor 510. Alternatively, the function of the processor 510 may be implemented on the image processing unit 530. In addition, the processor 510 and the processor 510 may implement a single function or a plurality of functions in cooperation with each other. For example, the image processing unit 530 may perform a part of the calculation relating to movement correction, and the processor 510 may perform the remaining calculation.

A determination unit 540 functions as a determination section for determining whether the workpiece 2 is non-defective/defective using the inspection image. For example, the determination unit 540 receives a result of the inspection performed using the inspection image in the image processing unit 530 and determines whether the inspection result satisfies a non-defective product condition (the tolerance or the like).

The storage device 520 stores spectral image data 521 which is data of the spectral image acquired by the camera 4, gray image data 522 which is data of the gray image generated by the MSI processing unit 511, and the setting information 523 holding the various control parameters. In addition, the storage device 520 also stores various types of setting data, a program code for generating the user interface, and the like. The storage device 520 may also store and hold the inspection image generated from the gray image and the like.

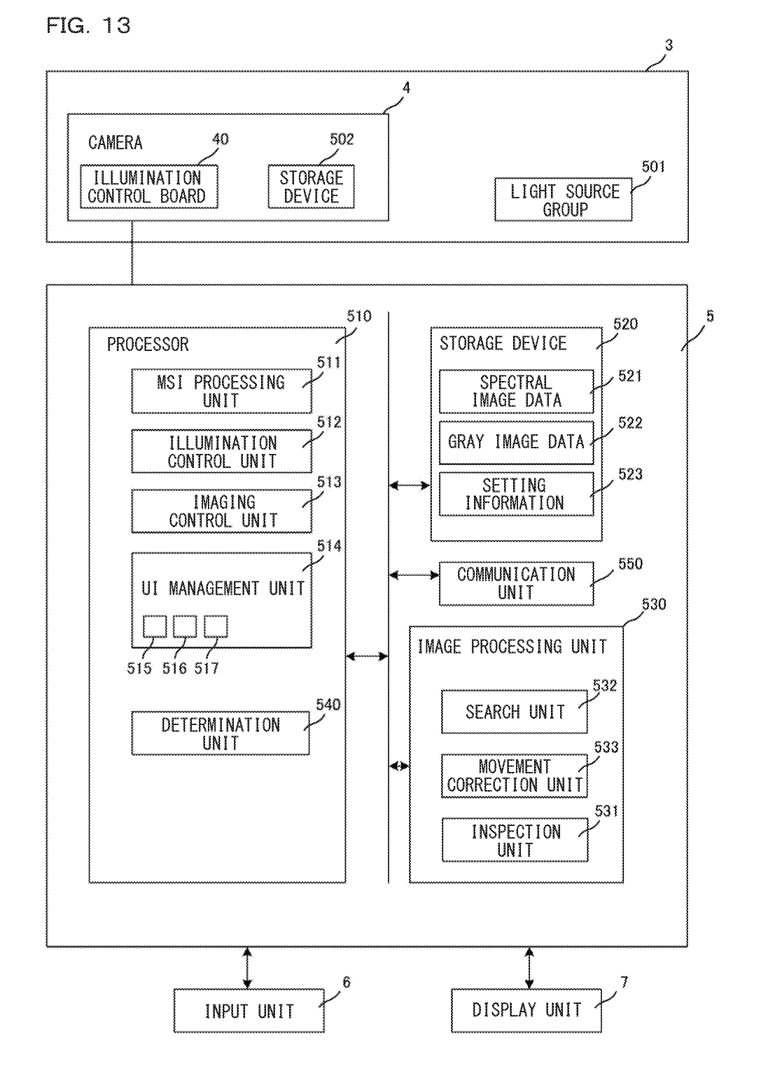

FIGS. 13 to 15 are diagrams illustrating another configuration example of the image processing device of the present invention. FIG. 13 is the diagram illustrating an example in which the illumination device 3 and the camera 4 are integrated, and the illumination control board 40 configured to control the illumination device 3 is provided in the camera 4. Since the illumination device 3 and the camera 4 are integrally provided in this configuration, it is not necessary to perform positioning at the time of installing the illumination device 3 and the camera 4. In addition, the illumination control board 40 configured to control the light source group 501 and the storage device 502 are unnecessary on the illumination device 3 side, and the general-purpose illumination device 3 that does not include the illumination control board 40 and the storage device 502 can also be used. The user can remove the illumination device 3 connected to the camera 4 and replace the illumination device 3 with another type of illumination device. For example, it is possible to appropriately select other types of illumination devices, such as a ring illumination that emits only white light, instead of the illumination device 3 used for the multi-spectral imaging in the present invention. It is preferable that the camera 4 recognize the type of the connected illumination device 3 and reflect the type on the setting user interface. Accordingly, the user can perform the illumination setting on the user interface corresponding to an item that can be set in the connected illumination device 3. A method in which the illumination device 3 stores illumination type information and the camera 4 refers to the information is conceivable as a method of recognition. In addition, the illumination control unit 512 and the imaging control unit 513 included in the image processing device 5 may be provided inside the camera 4, and control of an imaging and illumination system may be executed independently from the image processing device 5.

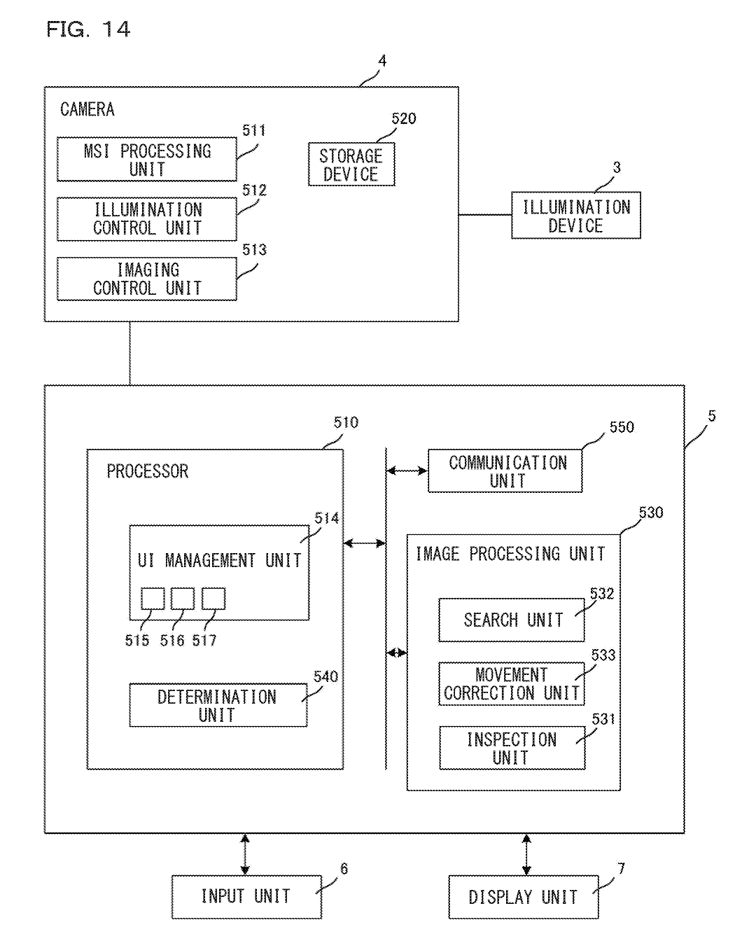

FIG. 14 illustrates the configuration example in which some functions of the image processing device 5 are provided on the camera 4 side. The camera 4 includes the storage device 502 that stores the spectral image data 521, the gray image data 522, and the setting information 523, and the MSI processing unit 511 executes the process of generating the gray image data 522 from the spectral image data 521 inside the camera 4. The illumination device 3 is controlled by the illumination control unit 512 of the camera 4. At the time of inspection setting, the camera 4 transmits the spectral image data 521 captured at each wavelength to the image processing device 5 and the gray image data 522 generated by the MSI processing unit 511 to the image processing device 5. At the time of setting, the image processing device 5 acquires the spectral image data 521 from the camera 4 and displays the acquired data on the display unit 7, so that the user can confirm the illumination intensity of each wavelength and whether the spectral image data 521 of each wavelength is necessary for inspection. On the other hand, at the time of inspection operation, only the gray image data 522 to be inspected may be transmitted to the image processing device 5 without transmitting the spectral image data 521 from the camera 4 to the image processing device 5. As the camera 4 is caused to have some functions of the image processing device 5 in this manner, a communication load between the camera 4 and the image processing device 5 is reduced, and the speed of processing increases due to distributed processing. The search unit 532 and the movement correction unit 533 may be provided in the camera 4 in order to generate the gray image data 522 by the camera 4.

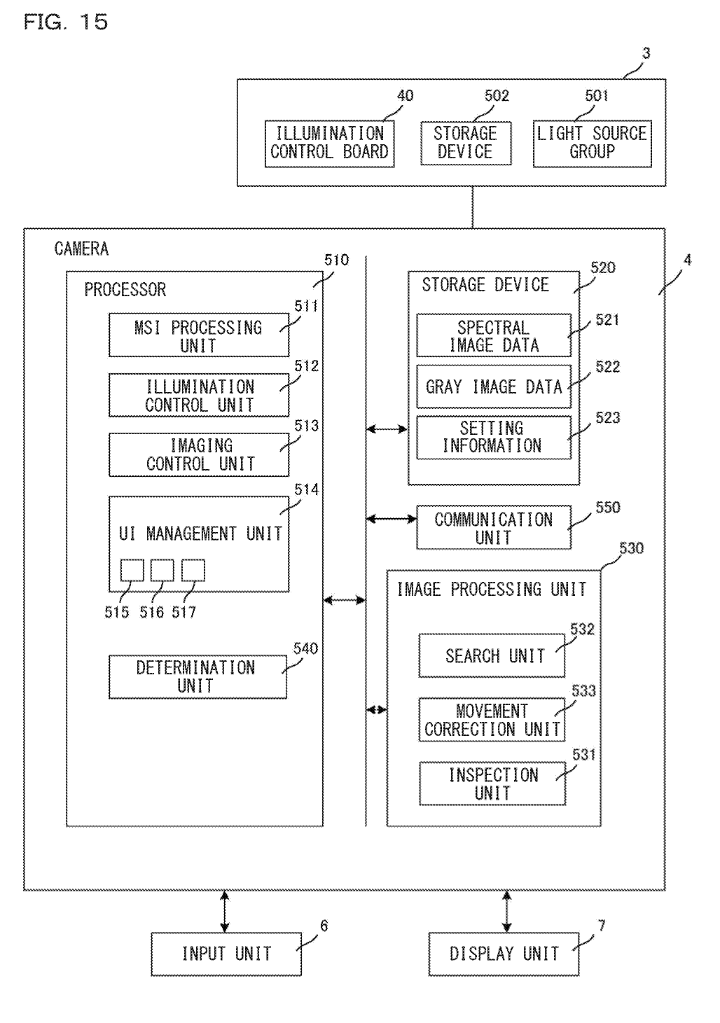

FIG. 15 is the configuration example in which all functions of the image processing device 5 are incorporated in the camera 4. It is sufficient for the user to install only the camera 4 and the illumination device 3, and thus, little time and effort is required at the time of installation. For example, this configuration may be advantageous when the camera 4 is allowed to have a large size and advanced image processing is unnecessary.

<Multi-Spectral Imaging>

In the multi-spectral imaging, the workpiece 2 is irradiated sequentially with illumination beams having different lighting colors (wavelengths) one by one, and an image for each wavelength is acquired. For example, eight images (spectral images) are acquired in the case of irradiation with illumination beams of eight types of wavelengths. The eight types of wavelengths are eight types of narrow-band wavelengths from an ultraviolet wavelength to a near-infrared wavelength. The narrow-band wavelength refers to a wavelength narrower than a width of a wavelength (wide-band wavelength) of light emitted by the white LED. For example, a width of a wavelength of light emitted by a blue LED is much narrower than the wavelength width of the light emitted by the white LED, and thus, the wavelength of the light emitted by the blue LED is the narrow-band wavelength. In the image inspection, there may be image inspection that does not require all of the eight spectral images. In this case, the workpiece 2 is irradiated with only an illumination beam of a necessary wavelength. In general, it is unlikely that the eight images are directly used for image inspection, one gray image is created from the eight images (color gray-scale conversion), and this gray image (color gray-scale image) is used for the image inspection. The color gray-scale conversion is sometimes called color-gray conversion. For example, binarization processing is executed on the color gray-scale image, edge detection processing is executed, or blob processing is executed so that whether a position, a size (a length or area) and a color of a characteristic (for example, a pin) in the workpiece 2 fall within tolerance ranges, respectively, are inspected.

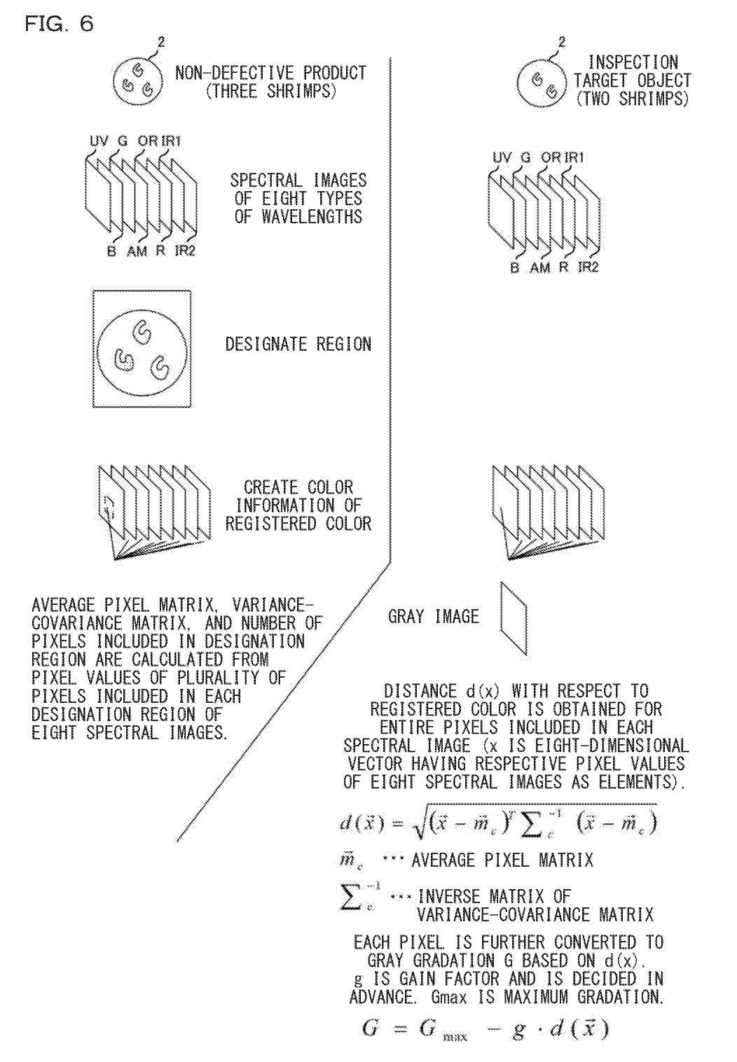

An example of the color gray-scale conversion will be described with reference to FIG. 6. When creating the gray image of the workpiece 2 which is the inspection target object, a registered color of a non-defective product (model) is required. This is because the gray image is created by converting the eight spectral images using color information of the registered color as a reference.

First, in a setting mode, the color information of the registered color is extracted from an image region (designation region) designated by the user in the eight spectral images acquired from the non-defective product. For example, when the non-defective product is an instant food (for example, Chinese noodle) and the number of certain ingredients (for example, shrimps) is counted by image inspection, the user displays an image of the non-defective product and designates a rectangular designation region including the ingredient in the non-defective product image, and the color information of the registered color is extracted from pixels included in the designation region. The color information of the registered color includes an average pixel matrix, a variance-covariance matrix, and the number of the pixels included in the designation region. The color information may be extracted by a so-called dropper tool. An UI of the dropper tool may be implemented on the region designation unit 516.

Next, eight spectral images are acquired for the workpiece 2 as the inspection target object in the inspection mode. A distance d(x) with respect to the registered color is obtained for all pixels included in each spectral image (x is an eight-dimensional vector having the respective pixel values of the eight spectral images as elements). Further, a product is obtained by multiplying the distance d(x) by a predetermined gain g, an offset a is added if necessary, and a difference G obtained by subtracting the product from a maximum gradation Gmax that each pixel can take becomes a gray gradation of a pixel x of interest. This is expressed as G=Gmax−(g·d(x)+a).

When there are a plurality of registered colors, a plurality of gray images are created using each registered color as a reference.

<Movement Correction>

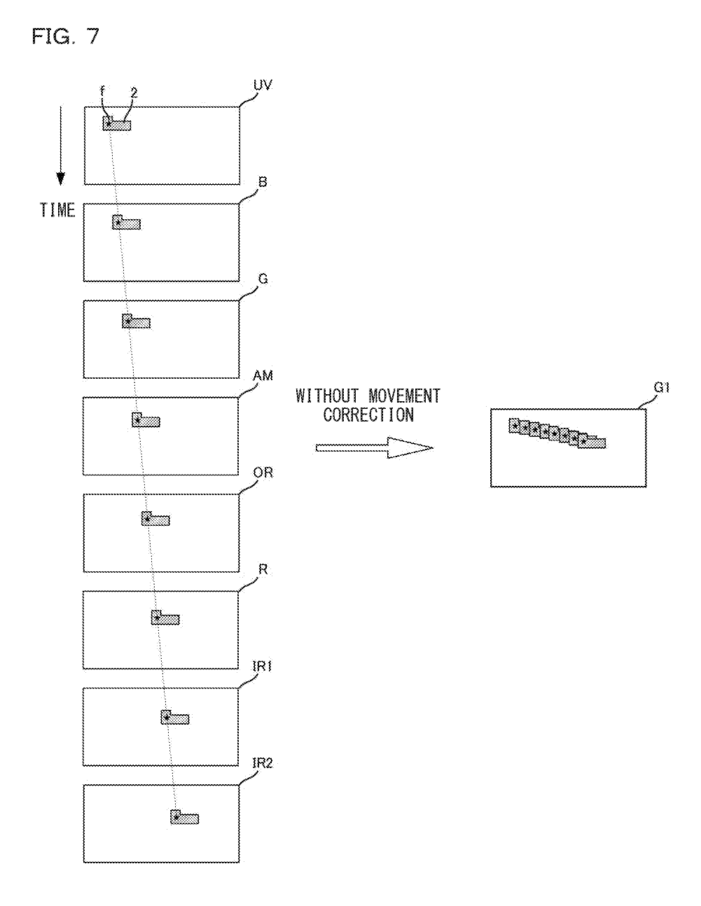

In the multi-spectral imaging, the workpiece 2 is irradiated with illumination beams of a large number of lighting colors one by one, and a large number of spectral images are generated. For example, as illustrated in FIG. 7, the workpiece 2 is sequentially irradiated with illumination beams of eight types of lighting colors from UV to IR2 so that eight spectral images are obtained, and one gray image is created by combining the eight spectral images. When the workpiece 2 is conveyed on the line 1, a position of the workpiece 2 in the first UV image and a position of the workpiece 2 in the eighth IR2 image deviate from each other. A deviation amount of the position of the workpiece 2 increases as the number of lighting colors increases and as conveyance speed of the line 1 increases. It is difficult to obtain a correct gray image if a gray image G1 is created ignoring this deviation, and thus, the accuracy of image inspection deteriorates. Accordingly, if a gray image is created after performing movement correction on the workpiece 2, a correct gray image is created.

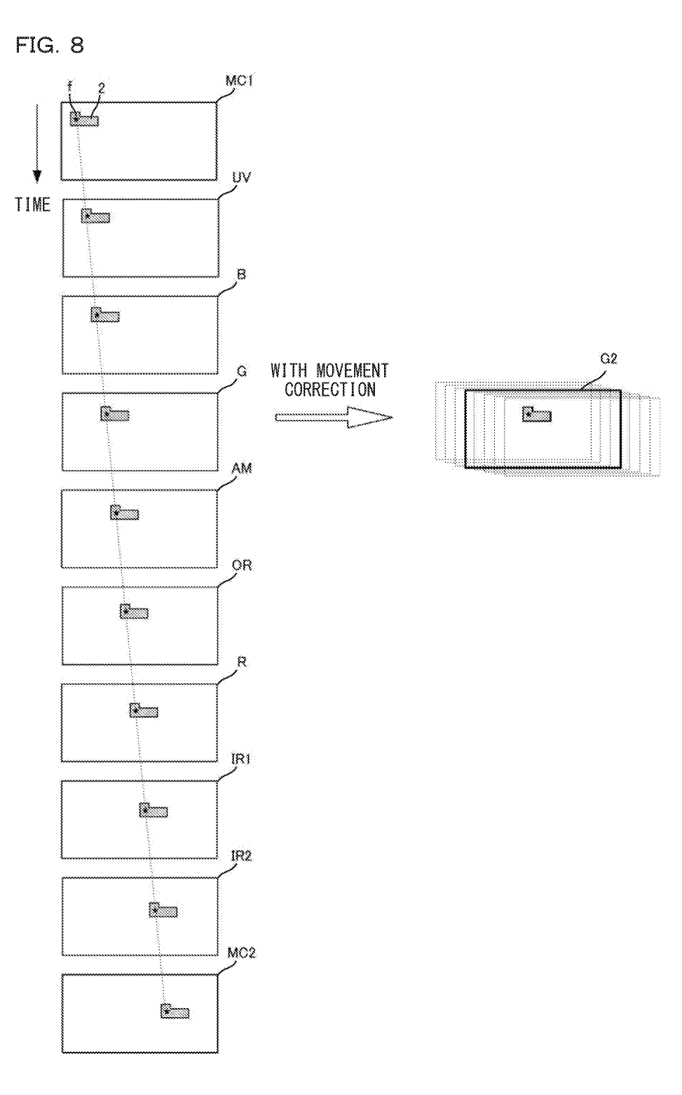

FIG. 8 illustrates a concept of the movement correction. In this example, images MC1 and MC2 for the movement correction are acquired before and after the eight types of spectral images for multi-spectral imaging are acquired. Since conveying speed of the workpiece 2 on the line 1 is constant, positions of the workpiece 2 in the respective images draw a linear locus. Accordingly, if a correspondence relationship (a deviation amount in an x-direction and a deviation amount in a y-direction) of coordinates of pixels constituting the workpiece 2 in each spectral image is obtained, it is possible to create a gray image G2 by superimposing the positions of the workpiece 2 in the respective spectral images on each other.

More specifically, a characteristic f of the workpiece 2 is detected by pattern search in the corrected images MC1 and MC2, and positions p1 and p2 of the characteristic f are obtained, respectively, from the images MC1 and MC2. The characteristic f may be a shape, an edge (an interval between two characteristic edges), or the like that can be detected by the pattern search. If a linear equation indicating changes of the positions p1 and p2 is obtained, it is possible to correct the position of the workpiece 2 in each spectral image. That is, the conversion formula of coordinates indicating the correspondence relationship in the coordinate system in each spectral image is decided.

When the workpiece 2 linearly moves, it is possible to perform the movement correction using two movement correction images. When the workpiece 2 moves non-linearly, three or more movement correction images are required. Here, a case where two movement correction images are used will be mainly described in order to simplify the description.

User Interface

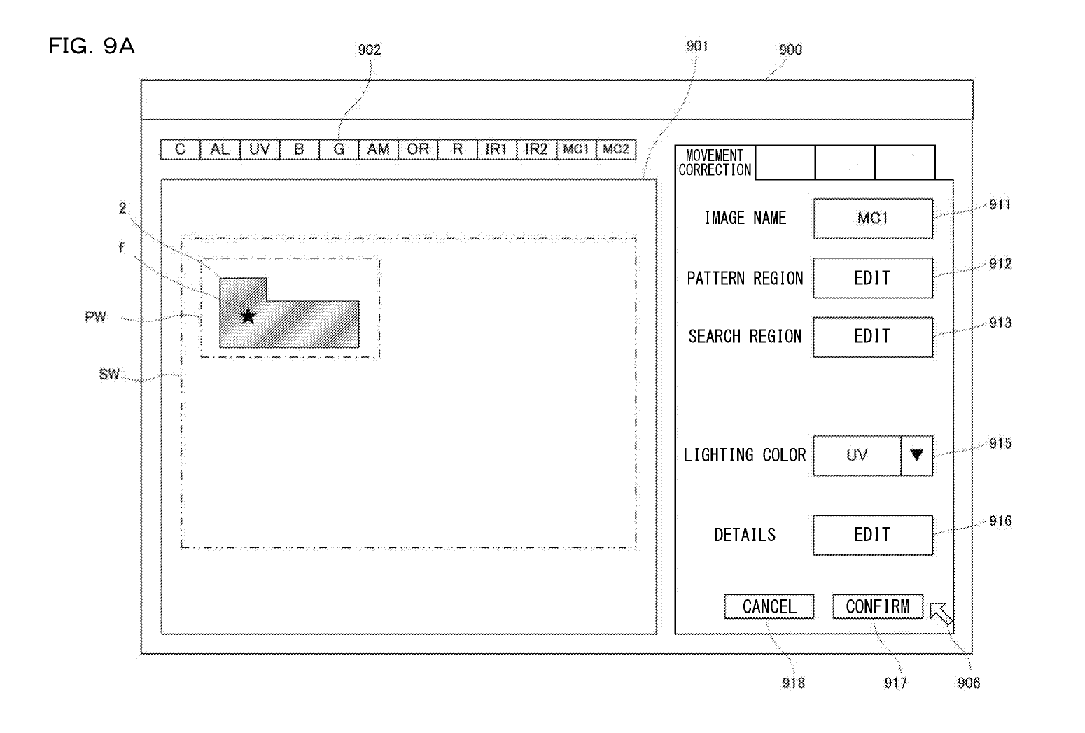

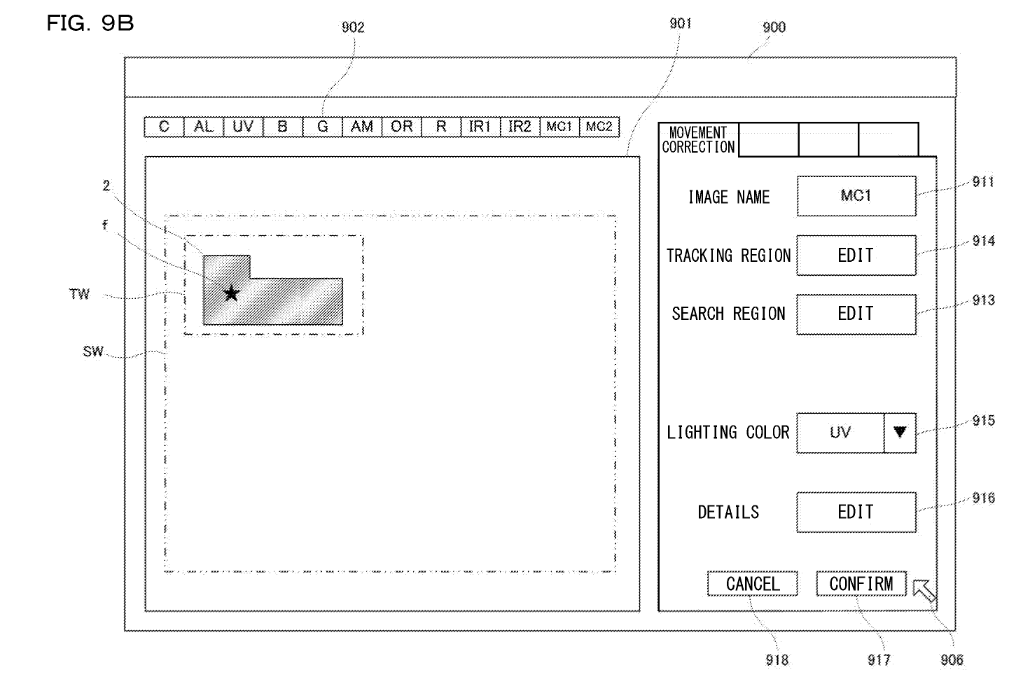

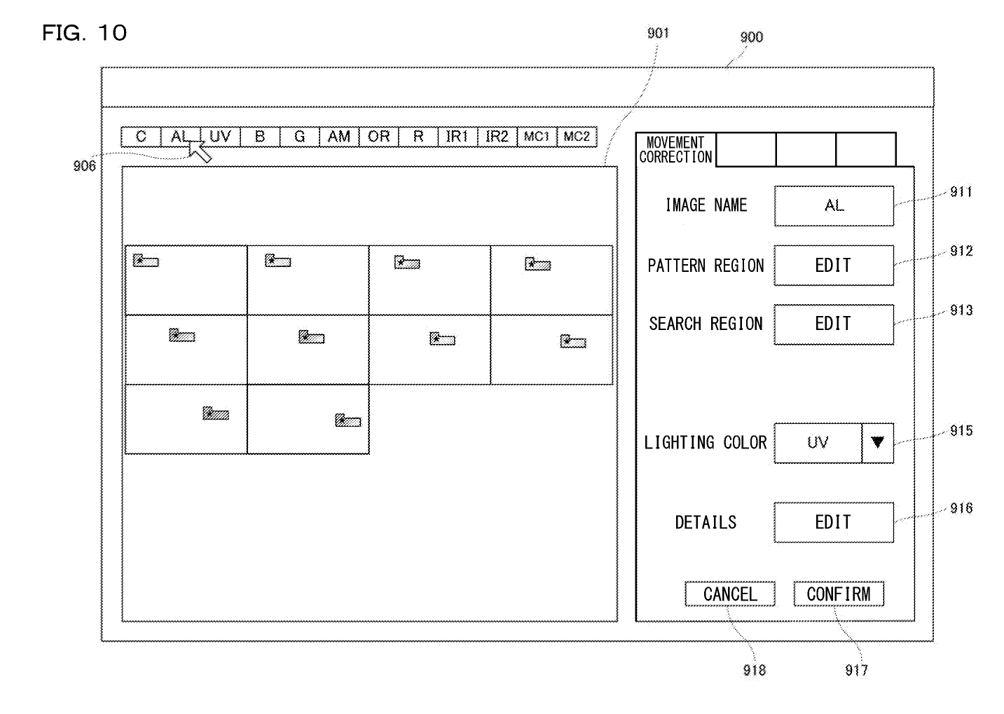

FIGS. 9A, 9B, and 10 illustrate user interfaces for setting of parameters relating to the movement correction. FIG. 9A illustrates a setting UI of a pattern search mode (pre-registration mode) in which a registration pattern is registered in a setting mode. In FIG. 9A, a setting UI 900 is displayed on the display unit 7 by the UI management unit 514 before the image inspection is executed. FIG. 9B illustrates a setting UI of a tracking mode in which a registration pattern is dynamically registered in the operation mode. As illustrated in FIG. 9B, in the tracking mode, a characteristic pattern serving as a reference of the movement correction is registered in an operation mode in which the image inspection is executed. The UI management unit 514 displays a characteristic pattern registration UI out of the setting UI 900 on the display unit 7 in the operation mode. The user arranges (sets) the tracking region TW configured to extract the registration pattern in the operation mode. As a result, a characteristic in the tracking region TW is extracted. The common items between FIG. 9A and FIG. 9B are denoted by the same reference numerals.

An image selection button 902 is a UI for selection of an image displayed in an image display region 901, and sends a selection result to the image selection unit 515.

In FIGS. 9A and 9B, C represents a color image created by combining a plurality of spectral images. AL represents all the spectral images of eight types.

When AL is operated by a pointer 906, the image selection unit 515 displays all the spectral images side by side in the image display region 901 as illustrated in FIG. 10. A plurality of movement correction images may be selected by being clicked by the pointer 906 from among the plurality of spectral images displayed side by side in this manner. The UI management unit 514 and the setting UI 900 may function as a reception unit that receives selection of a first movement correction image and a second movement correction image.

In FIGS. 9A, 9B, and 10, UV represents a spectral image acquired by an illumination beam of an ultraviolet wavelength. B represents a spectral image acquired by an illumination beam of a blue wavelength. G represents a spectral image acquired by an illumination beam of a green wavelength. AM represents a spectral image acquired by an illumination beam of an amber wavelength. OR represents a spectral image acquired by an illumination beam of an orange wavelength. R represents a spectral image acquired by an illumination beam of a red wavelength. IR1 and IR2 represent spectral images acquired by illumination beams of infrared wavelengths. Here, the wavelength of IR1 is shorter than the wavelength of IR2. MC1 is the first movement correction image. MC2 is the first movement correction image. The image of the workpiece 2 is displayed in the image display region 901 in FIGS. 9A and 9B.

An image name display field 911 is a text box that displays a name of an image displayed in the image display region 901. The image selection unit 515 inputs the name of the image into the text box.

In FIG. 9A, an edit button 912 is a button configured to edit a size and a position of the pattern region PW which is a region including a characteristic to be subjected to pattern search.

An edit button 913 is a button configured to edit a size and a position of a range (the search region SW) for searching the characteristic f for movement correction in the first movement correction image MC1.

In FIG. 9B, an edit button 914 is a button configured to edit a size and a position of a range (the tracking region TW) for dynamically registering the characteristic f for movement correction in the second movement correction image MC2. Each of the pattern region PW and the tracking region TW is the region to extract the characteristic f for movement correction and has the common function.

The characteristic f to be used to detect the position of the workpiece 2 in this manner may be pre-registered in the setting mode or dynamically registered in the operation mode.

In principle, registration of the search region SW and the pattern region PW is executed in the setting mode. When it is detected that these edit buttons are pressed by the pointer 906, the region designation unit 516 sets each region according to movement of the pointer 906. In addition, the image processing unit 530 extracts a characteristic in the pattern region PW or the tracking region TW and writes the extracted characteristic in the setting information 523. The characteristic to be extracted may be an image itself, a contour, or a plurality of edges.

A lighting color selection unit 915 is a pull-down menu for selection of a wavelength (lighting color) of an illumination beam to be used to acquire a movement correction image. The lighting color setting unit 517 writes identification information of the lighting color selected from the pull-down menu of the lighting color selection unit 915 to the setting information 523 as identification information to designate the lighting color for the illumination beam.

When the illumination device 3 is equipped with the white LED, W indicating the white LED may be selected as the lighting color of the illumination beam in the lighting color selection unit 915. In addition, AL, which means that light emitting elements of all lighting colors are to be turned on, may be selected in the lighting color selection unit 915. The search of the characteristic for movement correction is often stabilized when W or AL is selected. When any narrow-band wavelength from UV to IR2 is selected, a movement correction image and a spectral image for creating an inspection image may be shared. For example, when UV is selected, an UV image is used not only as the movement correction image but also as an element image for creating the inspection image. As a result, the number of images to be acquired is reduced, and the operation time relating to the movement correction is shortened.

An edit button 916 is a button configured to edit detailed settings. The detailed settings may include selection of one movement correction method from among a plurality of movement correction methods, setting of a search angle in pattern search, and the like. A confirm button 917 is a button configured to confirm settings relating to the movement correction. A cancel button 918 is a button configured to cancel the current settings and return to immediately preceding settings or default settings.

Flowchart

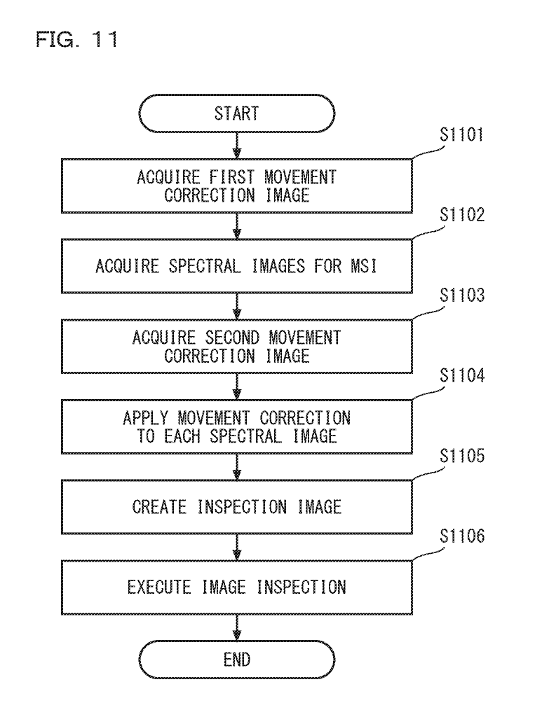

FIG. 11 is a flowchart illustrating the image inspection (operation mode) executed by the processor 510. Here, it is assumed that the pattern search mode is applied as the search mode for the movement correction. Thus, it is assumed that control parameters relating to the movement correction have already been decided in the setting mode. The order of S1101 to S1103 can be freely changed as long as the movement correction can be realized. However, it is assumed that S1103 is executed after S1101.

In S1101, the processor 510 acquires the first movement correction image. The processor 510 decides lighting colors of illumination beams of the first movement correction image according to the setting information 523, and sets the decided lighting color in the illumination control unit 512. The illumination control unit 512 instructs the illumination control board 40 to turn on a light emitting element of the designated lighting color.

The illumination control board 40 turns on the light emitting element of the designated lighting color. The processor 510 sets an imaging condition (an exposure condition and the like) according to the setting information 523 in the imaging control unit 513, and causes the imaging control unit 513 to acquire an image of the workpiece 2. The imaging control unit 513 controls the camera 4 according to the designated imaging condition to acquire the first movement correction image, which is the image of the workpiece 2, and writes the acquired first movement correction image in the storage device 520.

In S1102, the processor 510 (the MSI processing unit 511) acquires spectral images for multi-spectral imaging. The MSI processing unit 511 sets lighting colors of illumination beams in the illumination control unit 512 according to the setting information 523. The illumination control unit 512 instructs the illumination control board 40 to turn on a light emitting element of the designated lighting color. The illumination control board 40 turns on the light emitting element of the designated lighting color.

The processor 510 sets an imaging condition (an exposure condition and the like) according to the setting information 523 in the imaging control unit 513, and causes the imaging control unit 513 to acquire an image of the workpiece 2. The imaging control unit 513 controls the camera 4 according to the designated imaging condition to acquire the spectral images, which is the image of the workpiece 2, and writes the acquired spectral images in the storage device 520. In principle, the spectral image may be acquired for all of the eight types of lighting colors or may be acquired for some of the lighting colors. The lighting color used to acquire the spectral image depends on the setting information 523. When all spectral images designated by the setting information 523 are acquired, the processor 510 proceeds to S1103.

In S1103, the processor 510 acquires the second movement correction image. The processor 510 decides lighting colors of illumination beams of the second movement correction image according to the setting information 523, and sets the decided lighting color in the illumination control unit 512. The illumination control unit 512 instructs the illumination control board 40 to turn on a light emitting element of the designated lighting color. The illumination control board 40 turns on the light emitting element of the designated lighting color. The processor 510 sets an imaging condition (an exposure condition and the like) according to the setting information 523 in the imaging control unit 513, and causes the imaging control unit 513 to acquire an image of the workpiece 2. The imaging control unit 513 controls the camera 4 according to the designated imaging condition to acquire the second movement correction image, which is the image of the workpiece 2, and writes the acquired second movement correction image in the storage device 520.

In S1104, the processor 510 causes the image processing unit 530 to calculate a parameter for movement correction, and applies the movement correction to each spectral image using the parameter.

For example, in the pattern search mode, the movement correction unit 533 causes the search unit 532 to search a characteristic in the first movement correction image and to search a characteristic in the second movement correction image. In the tracking mode, the movement correction unit 533 causes the search unit 532 to search the characteristic registered using the first movement correction image in the second movement correction image. The movement correction unit 533 calculates a change amount between a position of the characteristic in the first movement correction image and a position of the characteristic in the second movement correction image.

The movement correction unit 533 corrects a correspondence relationship between coordinates of the respective pixels in the plurality of spectral images based on the change amount. For example, a correspondence relationship between coordinates of the workpiece 2 in an UV image and coordinates of the workpiece 2 in an IR1 image is obtained. As illustrated in FIG. 8, the positions of the workpiece 2 in the respective spectral images are superimposed on each other by correcting the coordinates in the respective spectral images using the obtained correspondence relationship (coordinate conversion formula), whereby an accurate gray image is created.

In S1105, the processor 510 (the MSI processing unit 511) converts a plurality of movement-corrected spectral images to create a gray image (inspection image). Several kinds of image processing may be applied to the gray image to create the inspection image.

In S1106, the processor 510 causes the inspection unit 531 to execute image inspection. The inspection unit 531 executes the image inspection on the inspection image, created by the MSI processing unit 511, using the inspection tool designated by the setting information 523. The determination unit 540 receives a result of the image inspection from the inspection unit 531 and determines whether the workpiece 2 satisfies the non-defective product condition.

Lighting Pattern

According to FIG. 8, an example of a lighting pattern of light emitting elements configured to acquire spectral images while performing movement correction is illustrated. According to this example, the light emitting element of the lighting color designated for the first movement correction image is turned on. Thereafter, the respective light emitting elements of UV, B, G, AM, OR, R, IR1, and IR2 are turned on. Finally, the light emitting element of the lighting color designated for the second movement correction image is turned on.

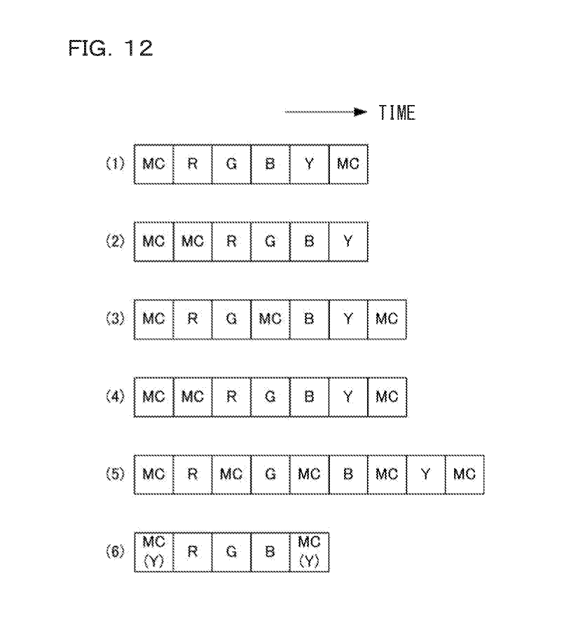

FIG. 12 illustrates six lighting patterns. Here, it is assumed that four lighting colors of R, G, B, and Y are used for multi-spectral imaging. Y is any lighting color other than RGB. MC is a common lighting color for the movement correction. FIG. 12 implies that a plurality of spectral images are acquired at equal intervals (constant time intervals).

Cases (1) and (2) are lighting patterns for linear correction. Case (1) illustrates that light emitting elements of lighting colors for movement correction are turned on before and after multi-spectral imaging so that two movement correction images are acquired. Case (2) illustrates that light emitting elements of lighting colors for movement correction are turned on before the multi-spectral imaging so that two movement correction images are acquired.

Cases (3) to (5) illustrate lighting patterns for non-linear correction. At least three movement correction images are required in order to execute the non-linear correction as described above. The accuracy of movement correction increases as the number of movement correction images increases, but the imaging time increases. The accuracy of movement correction may increase as the movement correction images are acquired in a distributed manner as in Cases (3) and (5).

Case (6) is a case where the spectral image for multi-spectral imaging is also used as the movement correction image. As a result, the total number of images is reduced, and the imaging time is shortened. That is, it is possible to execute inspection on more images in a short time.

### SUMMARY

As illustrated in FIG. 1 and the like, the illumination device 3 is an example of the illumination unit which has the plurality of light emitting elements (LEDs 33) that generates illumination beams of mutually different lighting colors, and individually irradiates the target object (for example, a non-defective product of the workpiece 2) with the illumination beams of the respective lighting colors.

The camera 4 is an example of the imaging unit which receives the light reflected from the target object for each illumination beam having one or more lighting colors and generates images of the target object. The processor 510 (the illumination control unit 512, the imaging control unit 513, and the like) is an example of the control unit which controls the illumination device 3 so as to irradiate the target object with the plurality of illumination beams having different lighting colors, and controls the camera 4 to generate the plurality of images each having the same or difference lighting color. The processor 510 controls the camera 4 via the imaging control unit 513 and causes the camera 4 to generate the plurality of spectral images at constant time intervals. In this manner, the processor 510 functions as the control unit which controls the illumination unit to irradiate the target object with the plurality of illumination beams having mutually different lighting colors, controls the imaging unit to generate a plurality of inspection images having mutually different lighting colors of illumination beams at constant time intervals, sets any of the plurality of inspection images or an image acquired by separately irradiating the target object with an illumination beam of any of the lighting colors as the first movement correction image, and generates the second movement correction image, which is any of the plurality of inspection images or acquired by separately irradiating the target object with an illumination beam of any of the lighting colors, acquired under the illumination beam of the same lighting color as the first movement correction image after the first movement correction image.

The search unit 532 searches the position of the characteristic pattern for each of the first movement correction image acquired under the illumination beam of the same lighting color among the plurality of images and the second movement correction image generated after the first movement correction image.

The MSI processing unit 511, the movement correction unit 533, and the like correct the correspondence relationship among the coordinates of the respective pixels in the plurality of images based on the change amount between the position of the characteristic pattern in the first movement correction image and the position of the characteristic pattern in the second movement correction image.

The inspection unit 531 executes the image inspection of the target object based on the plurality of images whose correspondence relationship of the coordinates of the pixels has been corrected by the correction unit. For example, the inspection unit 531 generates the gray image by combining the plurality of spectral images using the MSI processing unit 511, and executes the image inspection by using the gray image or an inspection image obtained by further performing image processing on the gray image.

As a result, the accuracy of the image inspection for the moving workpiece is improved in the image inspection device provided with the plurality of light sources having different lighting colors.

As described above, the lighting color of the illumination beam with which the target object is irradiated in order to generate the first movement correction image and the lighting color of the illumination beam with which the target object is irradiated in order to generate the second movement correction image are the same lighting color. As a result, the accuracy of movement correction is improved. That is, the illumination conditions are matched by using the same lighting color for at least two images for motion correction, and thus, the characteristic pattern is accurately detected so that the accuracy of movement correction is improved.

The lighting colors of the illumination beams with which the target object is irradiated are different from each other in order to generate a plurality of remaining images excluding the first movement correction image and the second movement correction image among the plurality of images. In this manner, the plurality of remaining images may be spectral images for multi-spectral imaging.

The processor 510 may turn on the plurality of light emitting elements simultaneously when generating the first movement correction image and the second movement correction image. As a result, the illumination beam close to white light is realized in a pseudo manner. That is, it is possible to omit the white light source.

It is a matter of course that the illumination device 3 may further include a white light emitting element (white LED or the like) that generates the white illumination beam. The processor 510 turns on the white light emitting element when generating the first movement correction image and the second movement correction image. There is also a characteristic pattern to be clarified by the white light. The white light is suitable for such characteristics.

The lighting color of the illumination beam with which the target object is irradiated in order to generate the first movement correction image and the lighting color of the illumination beam with which the target object is irradiated in order to generate the second movement correction image may be lighting colors that belong to the same narrow-band wavelength (narrow wavelength band). For example, both the first movement correction image and the second movement correction image may be acquired by a UV illumination beam.

However, the lighting color of the first movement correction image and the lighting color of the second movement correction image may be different from each other if the accuracy of movement correction can be sufficiently secured. For example, the first movement correction image and the second movement correction image may be acquired by illumination beams of IR1 and IR2, respectively.

It is the same characteristic pattern that is searched in both the first movement correction image and the second movement correction image. Thus, if the same or similar lighting color is used, the search accuracy of the characteristic pattern will be improved.

The display unit 7 may display a plurality of images side by side. The UI management unit 514 may function as the reception unit that receives selection of the first movement correction image and the second movement correction image from among the plurality of images displayed on the display unit 7. As the plurality of images are displayed side by side in this manner, the user can easily select an image suitable for the movement correction image.

In the setting mode in which the setting relating to the image inspection is executed, the UI management unit 514 and the region designation unit 516 may function as a registration unit that registers the characteristic of the region designated by the user on the displayed image of the target object as the characteristic pattern. The search unit 532 searches the characteristic pattern registered in advance by the registration unit in the operation mode in which the image inspection is executed. In this manner, the characteristic pattern may be registered in the setting mode which is executed before the inspection mode (operation mode).

The UI management unit 514 registers the characteristic of the region designated by the user for the first movement correction image generated in the setting mode as the characteristic pattern. In addition, the UI management unit 514 and the region designation unit 516 may receive the search region designated by the user on the first movement correction image or the second movement correction image generated in the setting mode. In general, coordinates of the search region are coordinates not depending on the position of the workpiece 2, for example, coordinates set with an upper left side of an image as a reference. In this case, the search unit 532 searches the characteristic pattern within the search region in the operation mode.

In the operation mode, the search unit 532 searches the characteristic pattern in the search region of the first movement correction image, and also searches the characteristic pattern in the search region for the second movement correction image.

The characteristic pattern may be dynamically registered in the operation mode in which the image inspection is executed. However, the search region for searching the characteristic pattern is set in the setting mode.

The UI management unit 514 and the region designation unit 516 function as a region reception unit that receives designation of the tracking region where a characteristic of an inspection target object is dynamically acquired in the operation mode in which the image inspection is executed. The UI management unit 514 and the region designation unit 516 also function as the registration unit that registers the characteristic existing within the tracking region of the first movement correction image acquired in the operation mode as the characteristic pattern. At this time, the coordinates of the characteristic in the first movement correction image are confirmed.

Further, the search unit 532 searches the characteristic pattern registered by the registration unit in the second movement correction image acquired in the operation mode. As a result, the coordinates of the characteristic in the second movement correction image are confirmed. That is, the parameters required for linear correction are confirmed.

The region reception unit may receive the tracking region designated by the user with respect to the second movement correction image among the first movement correction image or the second movement correction image. At this time, the coordinates of the characteristic in the second movement correction image are confirmed.

The search unit 532 searches the characteristic pattern registered by the registration unit in the first movement correction image generated in the operation mode. As a result, the coordinates of the characteristic in the first movement correction image are confirmed. That is, the parameters required for linear correction are confirmed.

The first movement correction image may be an image which is generated first among the plurality of images. In addition, the second movement correction image may be an image which is generated last among the plurality of images. As the movement correction images are acquired before and after the plurality of spectral images are acquired in this manner, the accuracy of movement correction will be improved. This is because estimation accuracy of the characteristic position by interpolation is higher than estimation accuracy of the characteristic position by extrapolation.

The search unit 532 may further search the position of the characteristic pattern for a third movement correction image generated after the second movement correction image. The movement correction unit 533 corrects the correspondence relationship among the coordinates of the respective pixels in the plurality of images between the first movement correction image and the second movement correction image based on the change amount between the position of the characteristic pattern in the first movement correction image and the position of the characteristic pattern in the second movement correction image. In addition, the movement correction unit 533 corrects the correspondence relationship among the coordinates of the respective pixels in the plurality of images between the second movement correction image and the third movement correction image based on the change amount between the position of the characteristic pattern in the second movement correction image and the position of the characteristic pattern in the third movement correction image. As three or more movement correction images are used in this manner, the movement correction will be accurately realized even in the case where the position of the workpiece 2 changes non-linearly.

What is claimed is:

1. An image inspection device configured to inspect an appearance of a workpiece moving in an inspection region in one direction, the image inspection device comprising:
an illumination unit which includes a plurality of light emitting elements that generates illumination beams of a plurality of mutually different lighting colors and irradiates a target object with the illumination beams of respective lighting colors;
an imaging unit which receives light reflected from the target object for each of illumination beams of one or more lighting colors and generates an image of the target object;
a control unit which controls the illumination unit to irradiate the target object with a plurality of illumination beams having mutually different lighting colors, controls the imaging unit to generate a plurality of inspection images having mutually different lighting colors of illumination beams at constant time intervals, sets any of the plurality of inspection images or an image acquired by separately irradiating the target object with an illumination beam of any of the lighting colors as a first movement correction image, and generates a second movement correction image, which is any of the plurality of inspection images or acquired by separately irradiating the target object with an illumination beam of any of the lighting colors, acquired under the illumination beam of the same lighting color as the first movement correction image after the first movement correction image;
a search unit which searches a position of a characteristic pattern for each of the first movement correction image and the second movement correction image;
a correction unit which corrects correspondence relationship among coordinates of pixels in the plurality of inspection images based on a change amount between a position of the characteristic pattern in the first movement correction image and a position of the characteristic pattern in the second movement correction image; and
an inspection unit which executes image inspection of the target object based on the plurality of inspection images with the correspondence relationship among the coordinates of the respective pixels corrected by the correction unit.

2. The image inspection device according to claim 1, wherein the lighting colors of the illumination beams, with which the target object is irradiated in order to generate a plurality of remaining inspection images excluding the first movement correction image and the second movement correction image among the plurality of inspection images, are different from each other.

3. The image inspection device according to claim 1, wherein the control unit turns on the plurality of light emitting elements simultaneously when generating the first movement correction image and the second movement correction image.

4. The image inspection device according to claim 1, wherein
the illumination unit further includes a white light emitting element that generates a white illumination beam, and
the control unit turns on the white light emitting element when generating the first movement correction image and the second movement correction image.

5. The image inspection device according to claim 1, wherein the lighting color of the illumination beam with which the target object is irradiated in order to generate the first movement correction image and the lighting color of the illumination beam with which the target object is irradiated in order to generate the second movement correction image are lighting colors that belong to a same narrow-band wavelength.

6. The image inspection device according to claim 1, further comprising a registration unit which registers a characteristic of a region designated by a user for a displayed image of the target object as a characteristic pattern in a setting mode in which setting relating to the image inspection is executed,
wherein the search unit searches the characteristic pattern registered by the registration unit in an operation mode in which the image inspection is executed.

7. The image inspection device according to claim 6, wherein the registration unit registers a characteristic of a region designated by the user for the first movement correction image generated in the setting mode as a characteristic pattern.

8. The image inspection device according to claim 6, wherein
the registration unit receives a search region designated by the user for the first movement correction image or the second movement correction image generated in the setting mode, and
the search unit searches the characteristic pattern in the search region in the operation mode.

9. The image inspection device according to claim 1, further comprising:
a region reception unit which receives designation of a tracking region where a characteristic of an inspection target object is dynamically acquired in an operation mode in which the image inspection is executed; and
a registration unit which acquires a characteristic existing within the tracking region of the first movement correction image acquired in the operation mode and registers the acquired characteristic as a characteristic pattern,
wherein the search unit searches the characteristic pattern registered by the registration unit for the second movement correction image acquired in the operation mode.

10. The image inspection device according to claim 1, further comprising:
a region reception unit which receives designation of a tracking region where a characteristic of a workpiece is dynamically acquired in an operation mode in which the image inspection is executed; and
a registration unit which acquires a characteristic existing within the tracking region of the second movement correction image acquired in the operation mode and registers the acquired characteristic as a characteristic pattern,
wherein the search unit searches the characteristic pattern registered by the registration unit for the first movement correction image acquired in the operation mode.

11. The image inspection device according to claim 1, wherein the first movement correction image is an image which is generated first among the plurality of inspection images.

12. The image inspection device according to claim 1, wherein the second movement correction image is an image which is generated last among the plurality of inspection images

13. The image inspection device according to claim 1, wherein
the search unit further searches a position of the characteristic pattern for a third movement correction image generated after the second movement correction image, and
the correction unit corrects a correspondence relationship among coordinates of pixels in a plurality of inspection images between the first movement correction image and the second movement correction image based on a change amount between the position of the characteristic pattern in the first movement correction image and the position of the characteristic pattern in the second movement correction image, and corrects a correspondence relationship among coordinates of pixels in a plurality of inspection images between the second movement correction image and the third movement correction image based on a change amount between the position of the characteristic pattern in the second movement correction image and a position of the characteristic pattern in the third movement correction image.
